(19) United States
(12) Patent Application Publication
(10) Pub. No.: US 2010/0153466 A1
(43) Pub. Date: Jun. 17, 2010

(54) SYSTEMS AND METHODS TO FACILITATE REPORT CREATION FOR NON-RELATIONAL DATABASES

(76) Inventor: Tomas Burger, Wiesloch (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/336,705

(22) Filed: Dec. 17, 2008

(51) Int. Cl. G06F 17/30

(52) U.S. Cl. 707/802; 707/E17.055

(57) ABSTRACT

According to some embodiments, a system, method, means, and/or computer program code are provided to facilitate report generation. In some cases, a list of nodes associated with a non-relational database may be gathered, the nodes in the list being oriented as a graph representing relations between the nodes. For each node in the list, node data may be automatically collected from the non-relational database on a node-by-node basis in accordance with the graph. Based on the collected node data, information may then be stored into a universal container, the stored information in the universal container being adapted to be accessed by a reporting tool.

### FIELD

Some embodiments of the present invention relate to business information, business intelligence, and/or enterprise systems. In particular, some embodiments relate to systems and methods to facilitate report creation for non-relational databases.

### BACKGROUND

An enterprise may store information, such as information about finances, employees, and products, in one or more databases. Moreover, such an enterprise may generate reports using the information stored in the databases. For example, the enterprise might distribute data about production and sales volume for various geographic regions on a quarterly basis.

Often, an enterprise will store the information in a “relational” database in accordance with common attributes found in the data set. For example, a table-like schema might be used to organize and store the information as records in a relational database. In this case, a number of standard reporting tools and processes are usually available to generate reports based on the relational database.

However, some enterprise applications (e.g., including those with persistent capabilities) do not use this type of record-oriented, relational database. Instead, an enterprise may use one or more object-oriented databases, where each entity in the database may be associated with a unique identifier (that itself may not have a meaning), and semantics and relations between the entities may be externally stored in identifier-to-identifier tables.

Unfortunately, this approach can make it difficult to use standard tools and processes to create reports. That is, because the tools and processes have been designed to work with relational databases (where source systems are arranged as sets of records), their use in connection with non-relational databases may be impractical.

It would therefore be desirable to provide improved methods and systems that facilitate the generation of reports even when information is stored in one or more non-relational databases. Moreover, it may be advantageous to provide tools and components that implement such methods and systems in an efficient and practical manner

### BRIEF DESCRIPTION OF THE DRAWINGS

FIG. 1 illustrates a system associated with generating reports based on information in a relational database.

FIG. 2 illustrates a graph representation of a non-relational database in accordance with some embodiments.

FIG. 3 illustrates a system associated with generating reports based on information in a non-relational database according to some embodiments described herein.

FIG. 4 is a flow diagram of a method to facilitate report generation according to some embodiments of the present invention.

FIG. 5 is a flow diagram of a method associated with data collection according to some embodiments of the present invention.

FIG. 6 is a block diagram of system associated with a universal container in accordance with some embodiments of the present invention.

FIG. 7 is a block diagram of an apparatus in accordance with some embodiments of the present invention.

### DETAILED DESCRIPTION

To alleviate problems inherent in the prior art, some embodiments of the present invention introduce systems, methods, computer program code and/or means to facilitate report creation for non-relational databases.

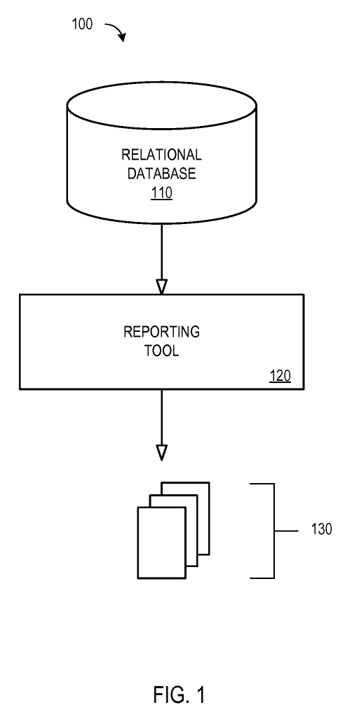

Consider, for example, FIG. 1 which illustrates a system 100 associated with the generation of reports based on information in a relational database 110. An enterprise may, for example, store information (e.g., about finances, employees, or products) in the relational database 110 using a table-like schema to organize the data as records.

In this case, a standard reporting tool 120, such as an Extract, Transform, Load (“ETL”) reporting tool, may be used to access the information in the relational database 110 in order to create and/or publish reports 130. The reporting tool 120 may, for example, help facilitate aggregation, sorting, ranking, filtering and the other standard reporting tasks.

However, some enterprise applications (e.g., including those with persistent capabilities) do not use this type of record-oriented, relational database 110. Instead, an enterprise may use one or more object-oriented databases, where each entity in the database may be associated with a unique identifier (that itself may not have a meaning), and semantics and relations between the entities may be externally stored in identifier-to-identifier tables. For example, many applications are written with object-oriented techniques and programming languages which may also be reflected in database modeling.

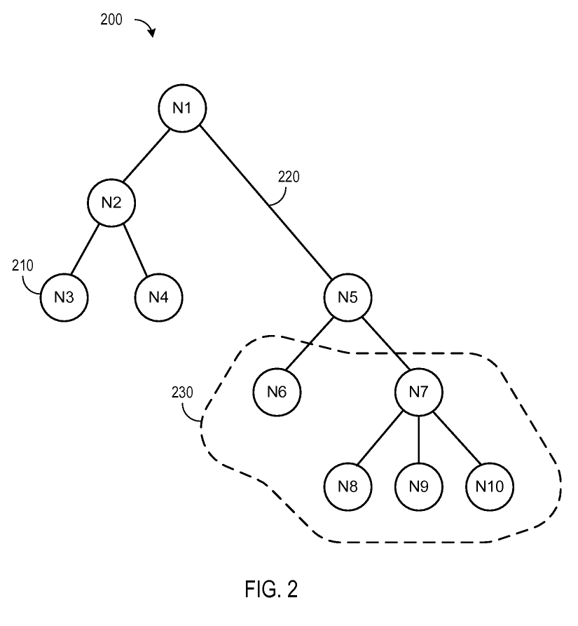

As an example of an object-oriented schema of objects and relations, consider FIG. 2 which illustrates a graph representation 200 of a non-relational database in accordance with some embodiments. In particular, the graph representation 200 indicates that the objects, or “nodes” 210 (e.g., N1 through N10) might be arranged through relationships 220 as a hierarchy where some nodes are children of other nodes. For example, the set 230 of nodes N6 through N10 are children (or grandchildren) of node N5.

Note that object-oriented data might be stored in specialized object-oriented databases or may be associated with Object Relational Mapping (“ORM”) stored in connection with a Relational Database Management System (“RDBMS”). In either case, the traditional relational database approaches to report generation may be inapplicable (e.g., because the objects are not linked to each other via the values of their fields).

Note that each object may be associated with a unique Object Identifier (“OID”) which represents an automated value with no semantics. That is, there may be no relation between the OID and the values of the attributes of the object. Moreover, the values might change arbitrarily while the OID remains the same for the entire life-span of the object. In addition when an object is persistent (e.g., as opposed to transient) the OID may remain the same even from session to session. The relations among the objects associated with an object-oriented database are not derived out of the attribute values, but may instead be explicitly stored as OID-to-OID links.

Unfortunately, this approach can make it difficult to use standard tools and processes to create reports. For example, because ETL reporting tools and processes have been designed to work with relational databases (where standard notions of select, join, and filter assume a source system arranged as sets of records), their use in connection with non-relational databases may be impractical. Note that even after an object's data is decomposed to tables and records and stored into a standard RDBMS, direct access to the tables by an ETL tool may still be impractical. For example, the entire business logic (which is now associated with classes and objects) would be bypassed and thus not contribute to the consistency and value of the reports. As another approach, such logic could be manually duplicated in ETL scripts, but this may significantly increase the cost of implementing and updating a report process.

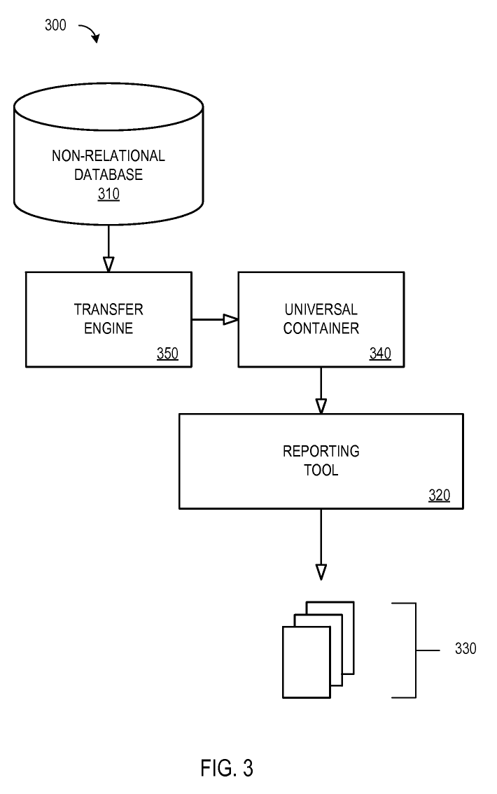

Thus, according to some embodiments of the present invention, object-oriented data may be transformed into a table-like format which can then be efficiently consumed by ETL tools. For example, FIG. 3 illustrates a system 300 associated with generating reports based on information in a “non-relational” database 310 according to some embodiments described herein. As used herein, the phrase “non-relational” database might refer to, for example, a database where information is not stored in a table-like scheme (e.g., an object-oriented database).

In particular, the system 300 may include a transfer engine 350 that accesses information from the non-relational database 310 and stores information into a universal container 340. A reporting tool 320 may then use the information in the universal container 340 to create reports 330. According to some embodiments, the transfer engine 350, the non-relational database 310, the universal container 340, and/or the reporting tool 320 may be co-located and/or incorporated within a single device.

Note that the transfer engine 350, the non-relational database 310, the universal container 340, and/or the reporting tool 320 may exchange information via one or more interfaces (e.g., a local interface connection or a communication network interface). Note also that elements described herein as communicating with one another may be directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between devices and/or systems may proceed over any one or more transmission protocols that are or become known, such as Asynchronous Transfer Mode (ATM), Internet Protocol (IP), Hypertext Transfer Protocol (HTTP), and/or Wireless Application Protocol (WAP). Although a single transfer engine 350, non-relational database 310, universal container 340, and reporting tool 320 are illustrated in FIG. 3, note that any number of such devices, as well as the other elements described herein, may be provided.

Moreover, some or all of the devices illustrated in FIG. 3 (as well as the other systems described herein) may use processor-executable program code read from one or more of a computer-readable medium, such as a floppy disk, a CD-ROM, a DVD-ROM, a magnetic tape, and a signal encoding the process, and then stored in a compressed, uncompiled and/or encrypted format. Note that embodiments are not limited to any specific combination of hardware and software. Moreover, the devices described herein might, for example, support any of the protocols in the following non-exhaustive list: Java Database Connectivity (JDBC), Java Connector (JCO), P4, and Simple Object Access Protocol (SOAP). Moreover, the databases might comprise a relational database accessible via a Structured Query Language (SQL) interface and/or systems which provide intermediary “business intelligence” to data stored within the database.

The transfer engine 350, the non-relational database 310, the universal container 340, and/or the reporting tool 320 might be associated with, for example, a workstation, a Personal Computer (PC), or a mobile wireless device, such as a laptop computer, a Personal Digital Assistant (PDA), a tablet computer, a handheld computer, or any other suitable devices that are or become known.

The objects stored in the non-relational database 310 and their relations may be considered, for example, as an oriented graph. Moreover, the transfer engine 350 may execute a “walking strategy” that describes how to walk the graph and which objects should be collected. Each object might, for example, know how to contribute to the data collection and may be asked by the transfer engine 350 to provide the “reporting data,” which can then be collected and stored in the universal container 340.

The universal container 340 may then be able to present the data into the reporting tool 320 (e.g., including a user interface infrastructure) as a standard record like system and/or persists the data in a data mart.

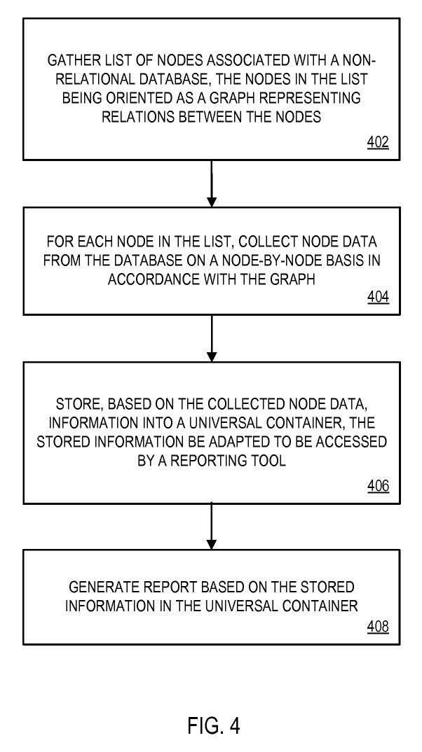

FIG. 4 is a flow diagram of a method to facilitate report generation that might be associated with, for example, the transfer engine 350 for FIG. 3 according to some embodiments of the present invention. The flow charts described herein do not necessarily imply a fixed order to the actions, and embodiments may be performed in any order that is practicable. Note that any of the methods described herein may be performed by hardware, software (including lower level code language), firmware, or any combination of these approaches. For example, a storage medium may store thereon instructions that when executed by a machine result in performance according to any of the embodiments described herein.

At 402, a list of objects or “nodes” associated with one or more non-relational databases may be gathered. The nodes in the list may be oriented, for example, as a graph representing relations between the nodes. The non-relational data might be associated with, for example, an object-oriented database and/or object relational mapping stored via a relational database management system. Moreover, as used herein the “graph” might be associated with a cyclic graph, a directed graph, an undirected graph, a mixed graph, a multi-graph, a hierarchy, and/or any other type of graph.

At 404, node data is automatically collected from the non-relational database for each node in the list on a node-by-node basis in accordance with the graph. For example, the collecting might include selecting a subsequent node based on a current node and a walking strategy. Moreover, the collecting might include, for a particular node, at least one of: (i) collecting for a result associated with that particular node, (ii) collecting for an aggregation of values to be associated with another node, (iii) collecting only when that particular node does not have a child node, or (iv) not collecting any information associated with that particular node.

According to some embodiments, column selection might be performed in connection with the non-relational database such that attributes are determined to define information to be eventually included in a universal container in accordance with a node type. Moreover, the collecting may be associated with filtering metadata. For example, the filtering metadata might be associated with one or more of: (i) requiring an exact match between a filter value and a field value for a node, (ii) using a filter value as a pattern to evaluate a field value for a node, (iii) using a pair of filter values as interval boundaries to evaluate a field value for a node, or (iv) only including a field value for a node if the field value qualifies in accordance with a ranking threshold.

At 406, information may be stored into a universal container based on the collected node data. The stored information in the universal container may be, for example, adapted to be accessed by a reporting tool. For example, at least some of the stored information in the universal container might be associated with a table-like schema. Note that at least some of the stored information in the universal container could be associated with keys, values, and/or attributes.

At 408, a report is generated based on the stored information in the universal container. For example, the report might be associated with an ETL reporting tool, a data mart persistent layer, and/or a reporting User Interface (UI).

Note that object-oriented data in a non-relational database might not be seen as the set of the records, but instead may be viewed as an oriented (usually acyclic) graph. The graph consists of nodes (object instances) where the data is available, and edges, which express relations among the objects. According to some embodiments, each node/object may be aware which class it belongs to, and the set of the classes may be given and non-volatile (stable).

The data collection process across the nodes or objects in the graph may be driven, according to some embodiments by report metadata. As will now be described, the metadata might be associated with, for example: a walking strategy, column selection, and/or filtering metadata.

A walking strategy might be associated with, for example, a sorted list of node types/object classes along with the specification of the data collection strategy. According to some embodiments, a walking strategy is designed by a developer (instead of an end user). One option for a walking strategy may be to “collect for a result.” For example, a node may be collected and subsequently is available forming a row in a table-like result. As another example, a walking strategy may “collect for the aggregation.” In this case, a node might be collected only as an input for an aggregation associated with another node (e.g., a parent node). After the values are aggregated, the record may be eliminated from the result.

In other cases, a walking strategy might “collect only if no children exist.” For example, consider a node type that is supposed to be available implicitly as the attribute of its child nodes. However, if a particular node of that type has no children, it still might be appropriate to place an indication associated with that node into a report. For example, if a report includes risks grouped by activity, all activities might be included even if some activities don't have any associated risks. As still another example, a walking strategy might simply “not collect” at all. In this case, a node may be excluded from the result (e.g., that node might simply be walked through as part of a path that leads to other nodes which are collectable).

Each node visited during a walking procedure may be required to provide information about a “next node” according to the walking strategy. These next nodes might be, for example, child nodes of the given “next node-type” according to the given walking strategy. In case of hierarchical nodes, the next node might include the child-nodes of the same type as the current node.

In addition to a walking strategy, metadata might be associated with “column selection.” For example, according to a “data model” each node type may be able to provide some attributes to the reporting. The list of the attributes required by the final report may be included in the metadata (and can help further narrow down the resulting data volume).

In addition to a walking strategy and column selection, metadata might be associated with “filtering metadata.” For example, filtering metadata might be associated with (i) a list of the filter criteria, eventually exposed via a reporting user interface to the end-user and/or (ii) a filtering strategy (e.g., how the filtering value is applied to the collected data).

By way of example, in an “exact” filtering strategy a filter value might need to match exactly with the value in the field (e.g., for currency filters or country code filters). As another example, in a “pattern” filtering strategy the filter value may be used as a pattern against the value of the field (e.g., for the entity name filtering and the like). As still another example, in an “interval” filtering strategy a pair of filter values may form window boundaries and the value in the field must fit within that window. Yet another example would be a “top X” (or “bottom X”) filtering strategy where the filter value might be an integer and only the rows where the field value ranks among top X values would be included.

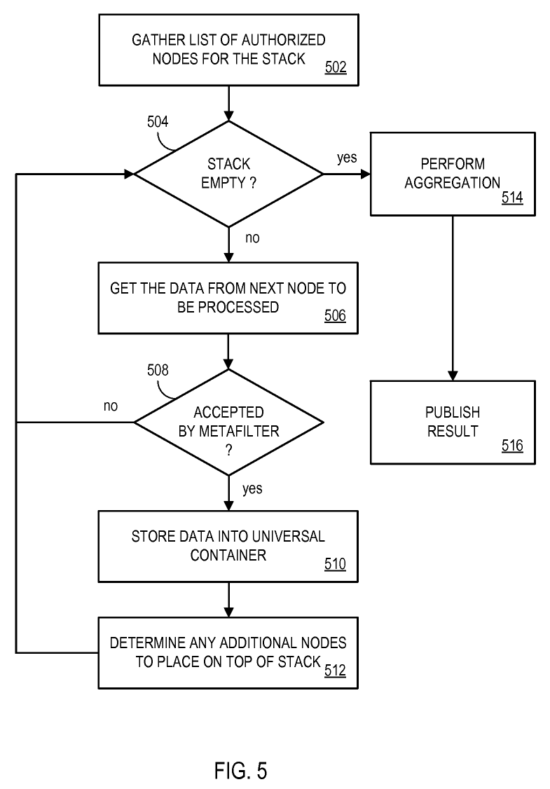

FIG. 5 is a flow diagram of a method associated with data collection according to some embodiments of the present invention. Note that the process of data collection may start at 502 where a list of authorized nodes is gathered for a stack (e.g., those where the reporting authorization is granted to the user). According to some embodiments, authorizations may be maintained on a per-node basis (and one of these authorizations may allow for the collection of data for reporting). Note that a walking process might initially grab all nodes from the database that are authorized for such reporting. Moreover, the authorization might be effective “downward” in a graph.

According to some embodiments, these are just the nodes where the walking process begins (not all the nodes that will be traversed). For example, a user may have authorization to view data for a specific set of organizational units. The nodes for these organizational units may therefore be loaded onto the stack. All of the objects/nodes related to those organizational unit nodes may then be accessed during the walking process.

Assuming the stack is not empty at 504, the process gets or loads data at 506 from a node currently being processed in the list (e.g., a node at the top of the stack). If the data is not accepted by a filter condition at 508, the process continues at 504. For example, if the data does not match an “exact” filter strategy the data might not be saved. If the data is accepted by the filter condition at 508, it is stored into a universal container at 510.

Any additional nodes associated with the current node may be determined (according to a next step of a walking strategy) and placed on top of the stack at 512, and the process may continue. When the stack is finally empty at 504, aggregation may be performed at 514 and a result may be published at 516 (e.g., the result may be persisted in a data mart or published to the reporting UI or ETL tool for further processing). Note that this process may work in the loop until the stack is empty. That is, the node from the top of the stack may be loaded (and removed from the stack).

Also note that for each node, the children of that node may (according to the walking strategy) be retrieved and similar processes might be performed for each child. Aggregation might then be performed, according to some embodiments, to aggregate information from all children to a parent. That node may then finally be added to a universal container (if required by the walking strategy). The node/object thus transfers the reporting data via an agreed interface into the entry storage of the universal container.

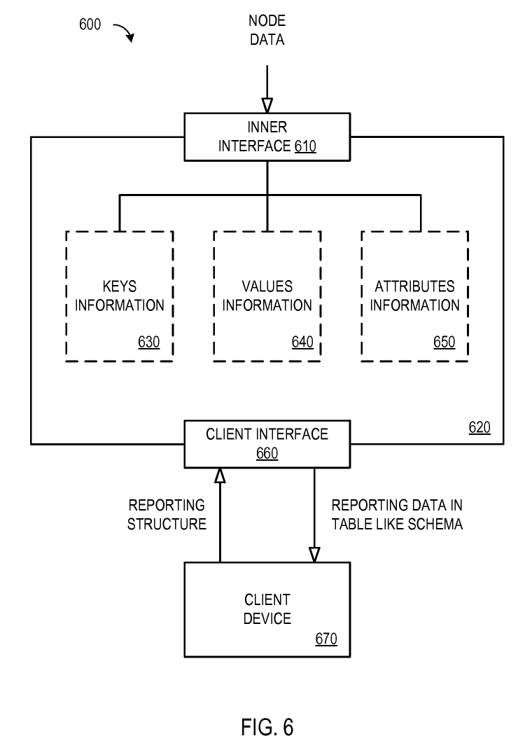

FIG. 6 is a block diagram of system 600 in accordance with some embodiments of the present invention. In particular, the system includes a universal container 620 (e.g., coupled to a transfer engine) that may receive node data (e.g., node-specific data) via an inner interface 610. A client device 670 (e.g., an ETL reporting tool) may be coupled to the universal container 620 via a client interface 660.

According to some embodiments, the universal container 620 further includes at least one of keys information 630, values information 640, and/or attributes information 650. For example, the universal container 620 may receive a chunk of node data and breaks it down into three parts: keys, values, and attributes.

The keys information 630 in the universal container 620 may be associated with, for example, attribute values, which may be unique to the entity. If available for the entity, it may be worthwhile to use some external identifier, but if nothing else is possible, the OID may be used instead. Note that each node may provide not only its own key value, but also the key values of the parents (according the walking strategy) as well as keys of “classifiers” (e.g., key values from some central secondary classification systems, which might be used for building of the reporting hierarchies, but which are not part of the walking strategy).

The values information 640 in the universal container 620 may be associated with, for example, numerical or other enumerated values, which may be collected per node and which may be used afterwards for aggregation (e.g., such that the values are further propagated “upwards” to other nodes).

The attributes information 650 in the universal container 620 may be associated with, for example, the standard attributes of the nodes, which may be relatively heterogeneous. The attributes information 650 may be, for example, used only for a “flat” report where the structure of the report row is supposed to be homogenous. In hierarchical reports, where different rows present different nodes in the hierarchy, attributes might be used, for example: (i) to form the level in the hierarchy, or (ii) to be present only on the rows where the node type fits.

The inner interface 610 of the universal container 620 may, for example, be targeted to the walking process, and may be designed to receive data from a single node and break it down to the required parts. According to some embodiments, the universal container may also participate in the interpretation of the filtering metadata.

The client interface 660 of the universal container 620 may be targeted to the consumers of the reporting infrastructure (e.g., data mart persistent layers, ETL tools, and/or reporting UIs). The client interface 660 may receive a “reporting structure” from the client device 670 (e.g., as a field catalog with a list of the desired columns) and provide the appropriate reporting data in a table-like schema (e.g., one row per collected node). Note that columns in the rows might make no further distinction between the keys, values, and/or attributes. Moreover, the object-oriented nature of the original data may be transformed into a desired table-like schema via the universal container 620.

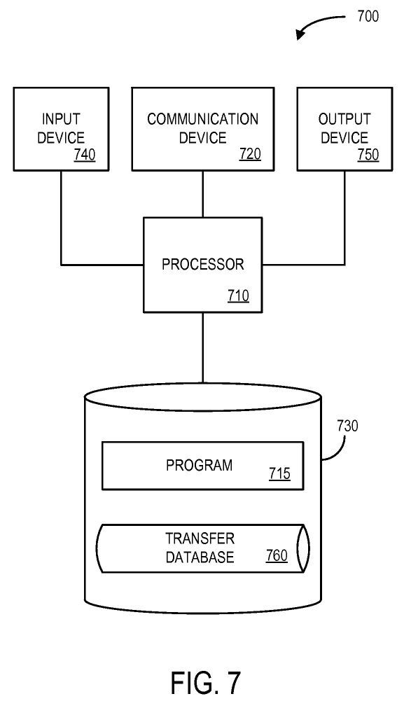

FIG. 7 is a block diagram of an apparatus in accordance with some embodiments of the present invention. The apparatus 700 might, for example, facilitate the secure transmission of data reports to different users having different access privileges. The apparatus 700 comprises a processor 710, such as one or more INTEL® Pentium® processors, coupled to a communication device 720 configured to communicate via a communication network (not shown in FIG. 7). The communication device 720 may be used to exchange database and/or report information (e.g., associated with remote databases or other devices including a client device that generates reports based on table-like schema information).

The processor 710 is also in communication with an input device 740. The input device 740 may comprise, for example, a keyboard, a mouse, or computer media reader. Such an input device 740 may be used, for example, to receive user selections associated with a reporting UI and/or transfer engine design parameters from a system developer. The processor 710 is also in communication with an output device 750. The output device 750 may comprise, for example, a display screen or printer. Such an output device 750 may be used, for example, to provide reports and/or display business information to a user.

The processor 710 is also in communication with a storage device 730. The storage device 730 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices.

The storage device 730 stores a program 715 for controlling the processor 710. The processor 710 performs instructions of the program 715, and thereby operates in accordance with any embodiments of the present invention described herein. For example, the processor 710 may (i) gather a list of nodes associated with a non-relational database, the nodes in the list being oriented as a graph representing relations between the nodes, and (ii) for each node in the list, collect node data from the non-relational database on a node-by-node basis in accordance with the graph.

The storage device 730 may also store a transfer database 760 that could be associated with, according to some embodiments, a non-relational database. According to other embodiments, the transfer database 760 might be associated with, for example, a universal container to store, based on the collected node data, the stored information being adapted to be accessed by a reporting tool. As used herein, information may be “received” by or “transmitted” to, for example: (i) the apparatus 700 from other devices; or (ii) a software application or module within the apparatus 700 from another software application, module, or any other source.

As a result of some of the embodiments described herein, improved methods and systems may be provided to facilitate the generation of reports even when information is stored in one or more non-relational databases. Moreover, tools and components are described that implement such methods and systems in an efficient and practical manner.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the applications and databases described herein may be combined or stored in separate systems). Similarly, although particular algorithms, information flows, and user interactions have been given as examples, other and/or additional steps may be performed in accordance with any embodiments described herein.

Moreover, Applicant has discovered that embodiments described herein may be particularly useful in connection with business intelligence and enterprise information. However, embodiments may be practiced with any type of information including data associated with financial institutions, medical providers, and the like.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer-readable medium having stored thereon processor-executable instructions, to facilitate report generation, that when executed by a processor result in the following:
gathering a list of nodes associated with a non-relational database, the nodes in the list being oriented as a graph representing relations between the nodes;
for each node in the list, automatically collecting node data from the non-relational database on a node-by-node basis in accordance with the graph; and
storing, based on the collected node data, information into a universal container, the stored information in the universal container being adapted to be accessed by a reporting tool.

2. The computer-readable medium of claim 1, wherein execution of the instructions further results in:
generating a report based on the stored information in the universal container.

3. The computer-readable medium of claim 1, wherein the non-relational data is associated with at least one of: (i) an object-oriented database, or (ii) object relational mapping stored via a relational database management system.

4. The computer-readable medium of claim 1, wherein the graph is associated with at least one of: (i) a cyclic graph, (ii) a directed graph, (iii) an undirected graph, (iv) a mixed graph, (v) a multi-graph, or (vi) a hierarchy.

5. The computer-readable medium of claim 1, wherein said collecting includes selecting a subsequent node based on a current node and a walking strategy.

6. The computer-readable medium of claim 1, wherein said collecting includes, for a particular node, at least one of: (i) collecting for a result associated with that particular node, (ii) collecting for an aggregation of values to be associated with another node, (iii) collecting only when that particular node does not have a child node, or (iv) not collecting any information associated with that particular node.

7. The computer-readable medium of claim 1, wherein execution of the instructions further results in column selection wherein attributes are determined to define information to be included in the universal container in accordance with a node type.

8. The computer-readable medium of claim 1, wherein said collecting is associated with filtering metadata.

9. The computer-readable medium of claim 1, wherein the filtering metadata is associated with at least one of: (i) requiring an exact match between a filter value and a field value for a node, (ii) using a filter value as a pattern to evaluate a field value for a node, (iii) using a pair of filter values as interval boundaries to evaluate a field value for a node, or (iv) only including a field value for a node if the field value qualifies in accordance with a ranking threshold.

10. The computer-readable medium of claim 1, wherein at least some of the stored information in the universal container is associated with a table-like schema.

11. The computer-readable medium of claim 10, wherein at least some of the stored information in the universal container is associated with at least one of: (i) keys, (ii) values, and (iii) attributes.

12. The computer-readable medium of claim 1, wherein the reporting tool is associated with at least one of: (i) an extract, transform, load reporting tool, (ii) a data mart persistent layer, or (iii) a reporting user interface.

13. A system to facilitate report generation, comprising:
a transfer engine to: (i) gather a list of nodes associated with a non-relational database, the nodes in the list being oriented as a graph representing relations between the nodes, and (ii) for each node in the list, collect node data from the non-relational database on a node-by-node basis in accordance with the graph; and
a universal container, coupled to the transfer engine, to store, based on the collected node data, information into a universal container, the stored information in the universal container being adapted to be accessed by a reporting tool.

14. The system of claim 13, further comprising:
a client device coupled to the universal container to generate reports based on table-like schema information in the universal container.

15. The system of claim 14, wherein the universal container further includes:
a client interface to: (i) receive reporting structure data from the client device, and (ii) provide the reporting data in the table-like schema to the client device.

16. The system of claim 13, wherein the universal container further includes at least one of: (i) keys information storage, (ii) values information storage, or (iii) attributes information storage.

17. The system of claim 13, further comprising:
a non-relational database coupled to the transfer engine, wherein the non-relational database is associated with at least one of: (i) an object-oriented database, or (ii) object relational mapping stored via a relational database management system

18. A method to facilitate report generation, comprising:
gathering a list of nodes associated with a non-relational database, the nodes in the list being oriented as a graph representing relations between the nodes;
for each node in the list, automatically collecting node data from the non-relational database on a node-by-node basis in accordance with the graph; and
storing, based on the collected node data, information into a universal container, the stored information in the universal container being adapted to be accessed by a reporting tool.

19. The method of claim 18, further comprising:
generating a report based on the stored information in the universal container.

20. The method of claim 18, wherein the non-relational data is associated with at least one of: (i) an object-oriented database, or (ii) object relational mapping stored via a relational database management system.
